(19) United States
(12) Patent Application Publication
(10) Pub. No.: US 2015/0106722 A1
(43) Pub. Date: Apr. 16, 2015

(54) Navigating Image Presentations

(71) Applicant: Apple Inc., Cupertino, CA (US)

(72) Inventors: Randy Ubillos, Los Altos, CA (US); Ralf Weber, San Jose, CA (US); Guillaume Vergnaud, Tokyo (JP)

(21) Appl. No.: 14/053,394

(22) Filed: Oct. 14, 2013

(51) Int. Cl. G06F 3/0488; G06F 3/0484

(52) U.S. Cl. CPC G06F 3/0488; G06F 3/04842; G06F 3/04845
USPC 715/731

(57) ABSTRACT

In some implementations, a computing device can be configured to generate a slide show type presentation based on images (e.g., digital photographs, videos, etc.) in a user's media library. While viewing the presentation, the computing device can receive user input to change the display of the images between a slideshow, a single image, and/or a grid view presentation mode. In some implementations, the user can provide input with respect to an image displayed on a slide to manipulate the image. In some implementations, the user can provide continuous input with respect to a slide to cause a transition animation to be displayed according to the amount and direction of user input received. For example, the speed, direction (e.g., forward, backward) and completion of the transition animation can be controlled by the user's input.

### TECHNICAL FIELD

The disclosure generally relates to presenting and navigating media.

### BACKGROUND

Most computing devices are configured to present media on a display of the computing device. For example, digital photographs, video, drawings or other media can be presented on the display. Often user will maintain media libraries that include collections of digital photographs and/or videos. The photographs and/or videos can be captured by the user using a digital camera and downloaded from the camera to the computing device for storage, for example. The computing device can be configured with software that allows the user to organize, navigate and/or edit the photographs and/or videos in the user's library. The software can be configured to allow the user to generate presentations (e.g., slideshows) that include the images in the user's media library.

### SUMMARY

In some implementations, a computing device can be configured to generate a slide show type presentation based on images (e.g., digital photographs, videos, etc.) in a user's media library. While viewing the presentation, the computing device can receive user input to change the display of the images between a slideshow, a single image, and/or a grid view presentation mode. In some implementations, the user can provide input with respect to an image displayed on a slide to manipulate the image. In some implementations, the user can provide continuous input with respect to a slide to cause a transition animation to be displayed according to the amount and direction of user input received. For example, the speed, direction (e.g., forward, backward) and completion of the transition animation can be controlled by the user's input.

Particular implementations provide at least the following advantages: Users gain greater control over the playback and/or display of images in presentations generated by the computing device. The user can quickly navigate between different playback modes and can quickly navigate between images.

Details of one or more implementations are set forth in the accompanying drawings and the description below. Other features, aspects, and potential advantages will be apparent from the description and drawings, and from the claims.

### DESCRIPTION OF DRAWINGS

FIG. 1 illustrates graphical user interfaces for generating an image presentation.

FIG. 2 illustrates a graphical user interface displaying a set of images in an image presentation.

FIG. 3 is a diagram illustrating navigation between image presentation modes.

FIG. 4 is a diagram illustrating navigation between image presentation modes.

FIG. 5 illustrates a graphical user interface for displaying a slide transition animation.

FIG. 6 illustrates a graphical user interface for manipulating images displayed in slideshow presentation mode.

FIG. 7 is flow diagram of an example process for navigating between slideshow presentation mode and single image presentation mode.

FIG. 8 is flow diagram of an example process for navigating between single image presentation mode and slideshow presentation mode.

FIG. 9 is flow diagram of an example process for navigating between slideshow presentation mode and grid view presentation mode.

FIG. 10 is flow diagram of an example process for controlling transition animations.

FIG. 11 is a flow diagram of an example process for manipulating an image displayed in an image grouping.

FIG. 12 is a block diagram of an example computing device that can implement the features and processes of FIGS. 1-11.

Like reference symbols in the various drawings indicate like elements.

### DETAILED DESCRIPTION

### Overview

This disclosure describes various Graphical User Interfaces (GUIs) for implementing various features, processes or workflows. These GUIs can be presented on a variety of electronic devices including but not limited to laptop computers, desktop computers, computer terminals, television systems, tablet computers, e-book readers and smart phones. One or more of these electronic devices can include a touch-sensitive surface. The touch-sensitive surface can process multiple simultaneous points of input, including processing data related to the pressure, degree or position of each point of input. Such processing can facilitate gestures with multiple fingers, including pinching and swiping.

When the disclosure refers to “select” or “selecting” user interface elements in a GUI, these terms are understood to include clicking or “hovering” with a mouse or other input device over a user interface element, or touching, tapping or gesturing with one or more fingers or stylus on a user interface element. User interface elements can be virtual buttons, menus, selectors, switches, sliders, scrubbers, knobs, thumbnails, links, icons, radio buttons, checkboxes and any other mechanism for receiving input from, or providing feedback to a user.

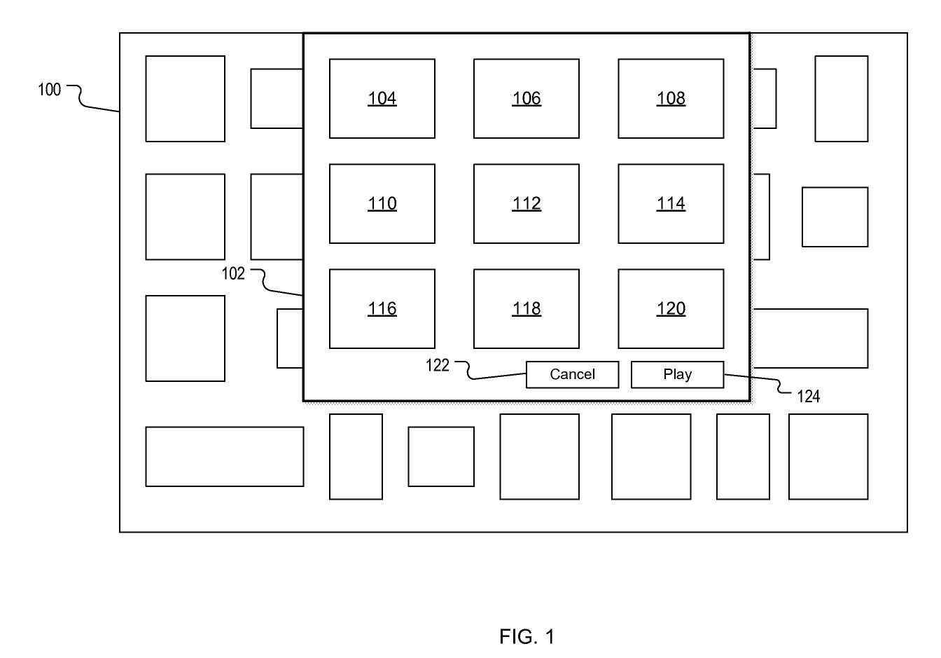

FIG. 1 illustrates graphical user interfaces 100 and 102 for generating an image presentation. For example, the image presentation can present images using a slideshow type presentation. GUI 100 can present a grid view layout of images stored in a computing device. For example, the grid view layout of GUI 100 can be presented in an editing mode of a media application running on the computing device. While in the editing mode, the user can modify the order of the images, adjust the size of the images and/or perform other edits on the images. The grid view layout can present images (e.g., digital photos, videos, etc.) corresponding to media stored in a media library of the computing device. The grid view layout can present photos stored in a digital photo album or other (user-defined) collection, for example.

In some implementations, the media application can generate an image presentation for presenting images stored in a media library. For example, the user can select a menu item of the media application to generate a slideshow of the images stored in a photo album. When the user selects the menu item (not shown), GUI 200 can be displayed. GUI 200 can include graphical objects 104-120 representing different templates or themes that define how to display images of a media library or album. For example, each template or theme can define the layout of images on a display (e.g., in a slide or image grouping), transition animations for moving between one set of images (i.e., slide) to the next set of images, and/or audio (e.g., music) to accompany the image presentation. In some implementations, a user can select a template or theme (e.g., theme 106) and select play button 124 to cause an image presentation to begin. Alternatively, the user can select cancel button 122 to return to viewing GUI 100 and editing the images in the media library.

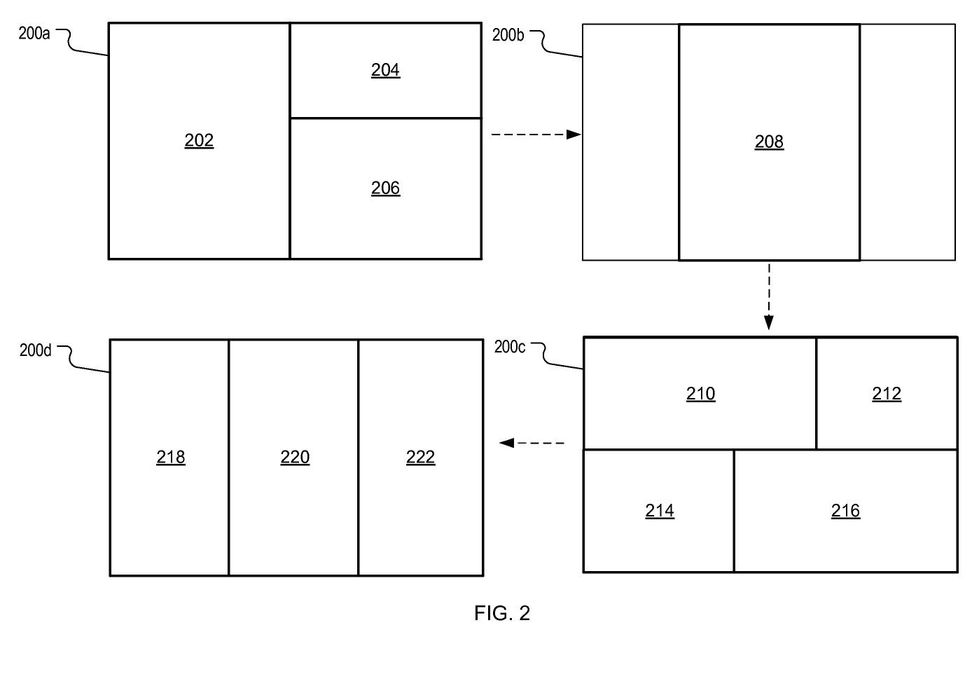

FIG. 2 illustrates a GUI 200(a-d) displaying a set of images in an image presentation. For example, an image presentation can be a slide show like presentation of images. Each “slide” (200a-c) in the slideshow can present one or more images according to a layout defined by the selected template or theme. In some implementations, images in an image library can be presented individually (e.g., like slide 200b, image 208). In some implementations, images in an image library can be presented with one or more other images (e.g., slides 200a, 200c, 200d). The layout of the images can be determined based on the selected template or theme, as described above. For example, images 202, 204 and 206 can correspond to the first three images in an image library or album. After a period of time, images 202, 204 and 206 can be automatically replaced with the next image 208 from the image library. After a period of time, image 208 can be replaced with images 210-216, for example. Thus, the image presentation can present all of the images (e.g., in consecutive fashion) in the image library, album or user-defined collection of images using slides. In some implementations, the user can provide input to cause the image presentation to display the next (e.g., one, two, three, four, etc.) images from the image library. For example, the user can tap a slide, input a swipe gesture (e.g., touch and drag finger) or perform some other input to cause the previous or next slide to be displayed. In some implementations, the presentation will automatically advance to the next slide (e.g., 200a to 200b to 200c to 200d) after a configured period of time has elapsed.

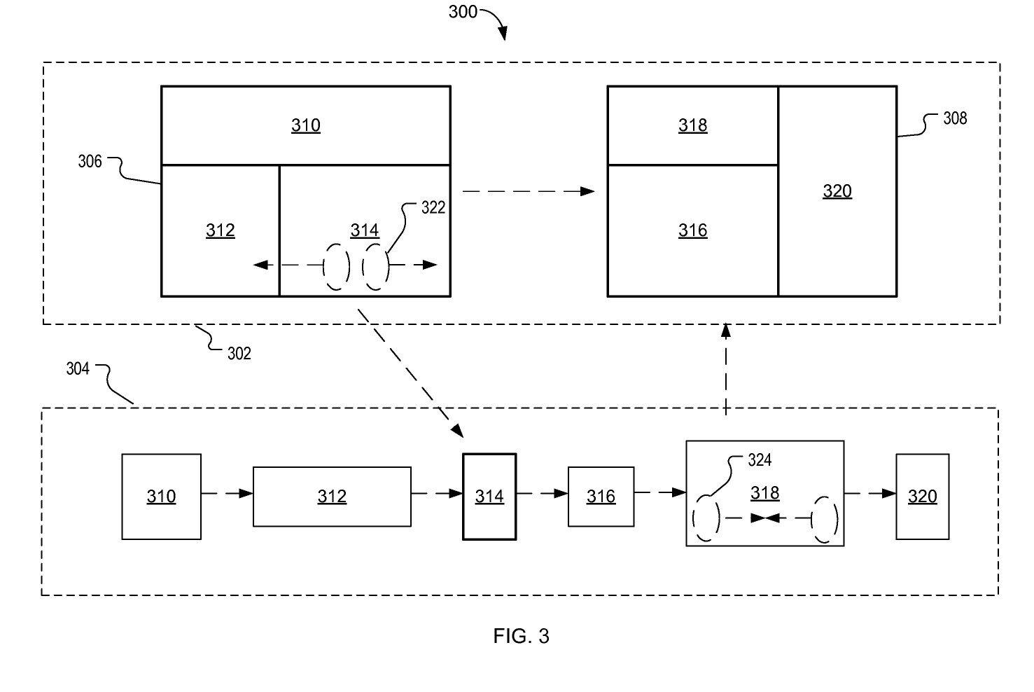

FIG. 3 is a diagram 300 illustrating navigation between image presentation modes. For example, while viewing an image presentation, a user can provide input to switch the display between slideshow mode 302 and single image mode 304. For example, while in single image mode, the computing device can be configure to display only one image at a time. In some implementations, a user can cause the computing device to display images (e.g., digital photos, videos, etc.) in a slideshow presentation mode. For example, a user can select a template or theme and cause the computing device to display images in slideshow like fashion, as described above with reference to FIG. 1. In slideshow presentation mode, the computing device can arrange a group of (e.g., 1, 2, 3, 4, etc.) images for simultaneous display. After a first group of images (i.e., first “slide”) is displayed, a second group of images (i.e., second “slide”) can be displayed. For example, image grouping 306 can be configured to present images 310-314. After image grouping 306 is displayed, image grouping 308 can be displayed to present images 316-320. The transition from image grouping 306 to image grouping 308 can be triggered automatically after a time period has elapsed. The transition from image grouping 306 to image grouping 308 can be triggered in response to user input received by the computing device.

In some implementations, the computing device can receive user input to switch between slideshow mode 302 and single image mode 304. For example, while in slideshow mode, the computing device can display image grouping 306 to display images 310, 312 and 314. If the user wishes to view image 314 in greater detail, the user can provide input with respect to image 314 to cause image 314 to be displayed individually (e.g., in full screen mode on the display). For example, while image 314 is displayed in image grouping 306, the user can touch an area of the display that is associated with image 314 and perform a de-pinch gesture 322 (e.g., move fingers apart, opposite of pinch movement) while touching the display to cause image 314 to be displayed in single image mode 304.

In some implementations, while in single image mode 304, the user can view other images in a library, album or collection. For example, when in single image mode 304 and displaying image 314, the user can provide user input (e.g., a left to right swipe touch input gesture) to move backward in the sequence of images to view image 312. The user can provide user input (e.g., a right to left swipe touch input gesture) to move forward in the sequence of images to view image 316 in single image mode 304. In some implementations, the computing device can automatically move through the sequence of images 310-320 while in single image mode 304. For example, if the user provides input to cause image 314 to be displayed in single image mode 304, then after image 314 has been displayed for a period of time (e.g., 10 seconds), the next image in the sequence (e.g., image 316) can be automatically displayed.

In some implementations, while in single image mode 304, the user can provide input to a displayed image (e.g., image 318) to cause the image presentation to change to slideshow mode 302. For example, if a user inputs a pinch gesture 324 with respect to image 318 (e.g., provides a touch input gesture to the area of the display where image 318 is displayed), then the computing device can display image grouping 308 that includes image 318 in slideshow mode 302. For example, the computing device can determine an image grouping in the slideshow presentation that includes image 318. The image grouping that includes image 318 will be displayed in response to the user providing input associated with image 318 in single image mode 302. Thus, by providing touch input (e.g., pinch and de-pinch gestures), the user can switch between presentation modes (e.g., slideshow mode 302, single image mode 304).

In some implementations, the computing device can automatically switch from single image mode 304 to slideshow mode 302. For example, if the user previously provided input to switch from slideshow mode 302 to single image mode 304, while in single user mode 304 the computing device can automatically return to slideshow mode 302 if the user has not provided any user input for a period of time. For example, when the computing device determines that no user input has been received for a configured period of time (e.g., the configured period of time has elapsed), the computing device can automatically resume presenting images in slideshow mode 302. The computing device can automatically resume presenting images in slideshow mode 302 by presenting a slide that includes the image displayed in single image mode 304 when the configured period of time elapsed, for example.

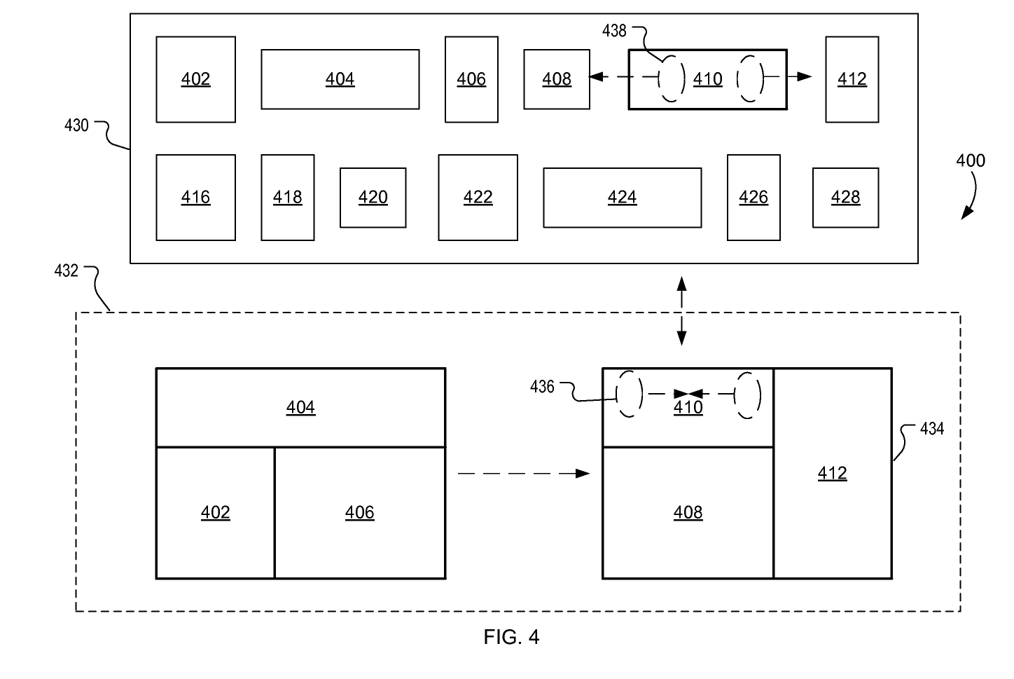

FIG. 4 is a diagram 400 illustrating navigation between image presentation modes. For example, a computing device can be configured to display images in a slideshow presentation mode 432, as described above with reference to FIG. 3. While viewing images in slideshow mode 432, the user can provide input with respect to an image displayed in an image grouping (e.g., a slide). For example, the user can provide touch input with respect to image 410 displayed in image grouping 434 in the form of a pinch gesture 436. When the pinch gesture 436 is received, the computing device can display image grid view 430 so that the user can navigate through the various images 402-428 in the image library, album or collection. For example, if the pinch gesture 436 is received with respect to image 410, the grid view 430 can be displayed with image 410 displayed and/or highlighted in the grid view 430.

In some implementations, the image grid view 430 can be manipulated by the user so that other images in the library, album or collection are displayed in the image grid view 430. For example, if there are more images in the library, album or collection than can be displayed at one time in the grid view 430, the user can provide input (e.g., touch input, up/down swipe gesture, etc.) to cause the grid view 430 to scroll so that other images can be displayed.

In some implementations, once the user has found an image that the user wishes to view, the user can provide input to switch back to the slideshow presentation mode 432. For example, if the user wishes to view image 410 in slideshow mode 432, the user can input a de-pinch gesture 438 to cause a corresponding image grouping 434 that includes image 410 to be displayed. Thus, the user can provide input to switch between the grid view presentation mode 430 and slideshow presentation mode 432.

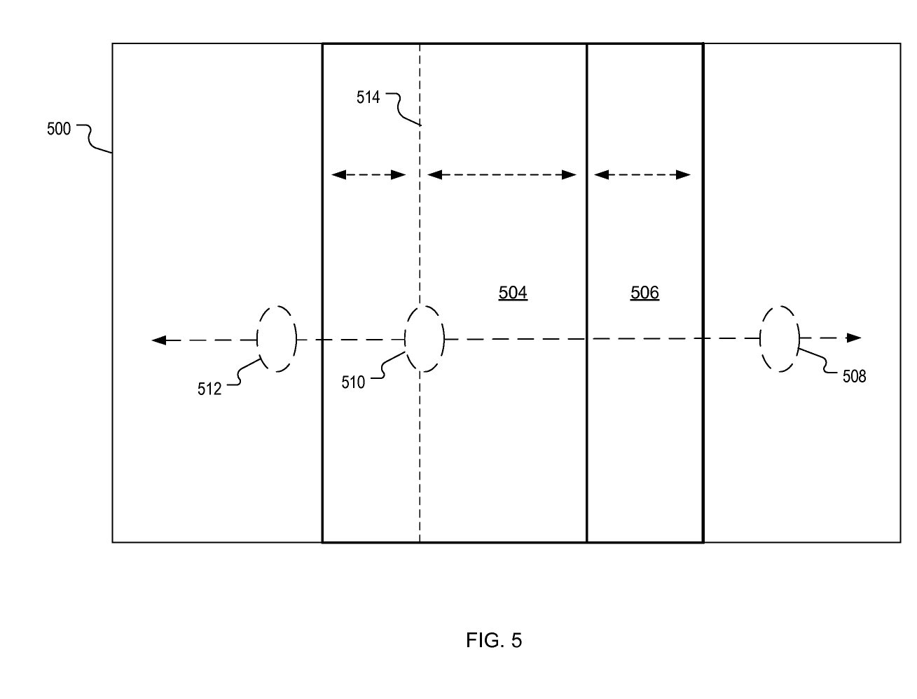

FIG. 5 illustrates a graphical user interface 500 for displaying a slide transition animation. For example, a user can provide input to GUI 500 to control the amount and direction of the transition animation. The amount and direction of the animation can correspond to the amount and direction of user input, for example.

In some implementations, a computing device can be configured to display images in a slideshow presentation mode, as described above. The computing device can display a grouping of images (e.g., a slide). After a configured period of time, a next grouping of images can be automatically displayed. The transition between the first grouping of images and the next grouping of images can be animated using various transition animations (e.g., fade from one group to another, slide one group off the display while another group slides into view, etc.). The animation can last for a period of time. For example, if the transition animation uses a sliding animation to replace one slide with another slide, the sliding animation can last for a second or two. The transition animation can have a direction (e.g., forward, backward). For example, the forward animation direction can be the animation showing a transition from a current slide to the next slide. The backward animation direction can be the reverse of the forward animation (e.g., the transition from the next slide to the current slide, or from the current slide to the previous slide).

In some implementations, a user can provide input to control the transition animation. For example, a user can input a touch gesture (e.g., left or right swipe) to control movement between image groups or slides. A left swipe can cause the next slide to be displayed. A right swipe can cause the previous slide to be displayed. For example, the next or previous slide can be displayed once the user stops touching the touch sensitive display. In some implementations a transition animation is presented when moving between slides.

In some implementations, the user can control the transition animation by continuously touching the touch sensitive display while performing a swipe gesture. For example, while the user continues to touch the touch sensitive display, the user can slide the user's finger back and forth across the touch sensitive display to control the amount and direction of the animation. For example, GUI 500 can present a slide displaying image 504. The computing device can receive a touch input 508 (e.g., a single finger touch) where the user drags or swipes the touch input across GUI 500. In response to receiving the swipe gesture input, the transition animation to the next image 506 can be initiated and displayed on GUI 500. For example, the transition animation of FIG. 5 can be a slide or push animation that causes one slide or image to push another slide or image off GUI 500 so that the second slide or image replaces the first slide or image.

In FIG. 5, image 506 can be seen pushing in on image 504 from the right hand side of image 504. As the user continues to swipe the touch input to touch location 510, more of image 506 will be displayed (e.g., to dotted line 514) and less of image 504 will be displayed. If the user continues with the swipe touch input to location 512 and removes the touch input, image 506 will replace image 504 on GUI 500 and the transition animation will be complete. However, if the user reverses the direction of the touch input from input location 510 to input location 508 without terminating the touch input, then the transition animation can be reversed. For example, the transition animation showing image 506 sliding across GUI 500 and pushing image 504 off the display can be reversed so that more of image 504 is displayed and less of image 506 is displayed. In some implementations, if the user's reverse swipe touch input goes past the initial point of touch input (e.g., 508), then a transition from the current slide to the previous slide (e.g., the slide before the current slide) can be displayed. Similarly, if the user initiates a touch input gesture to present a transition from the current slide to the previous slide, the user can reverse the touch input gesture and continue to past the initial touch input location to cause a transition from the current slide to the next slide to be displayed. Thus, with a single continuous touch input gesture the user can cause both a forward transition from the current slide to the next slide to be displayed and a backward transition from the current slide to the previous slide to be displayed.

In some implementations, the amount of transition animation displayed can correspond to the amount, distance, or length of the swipe touch input gesture. For example, if the continues to provide touch input and slides the touch input a short distance across GUI 500, then only a small portion of the transition animation will be displayed. If the user continues to provide touch input and slides the touch input across most of GUI 500, then most of the transition animation will be displayed. Thus, the user can provide touch input to cause the slideshow image presentation to display the entire transition animation or a portion (e.g., less than all) of the transition animation. The amount of transition animation presented can correspond to the amount of movement in the swipe gesture, for example.

In some implementations, if the slideshow is automatically transitioning from one slide to another, the user can interrupt the transition animation. For example, if the user provides input (e.g., quick swipe, non-continuous touch input) to display the next slide or if the next slide is automatically presented, an transition animation from the current slide to the next slide can be displayed, as described above. While the transition animation is being displayed, the user can provide touch input (e.g., a single finger touch) to pause (or catch) the animation and continue to provide touch input to control the playback of the transition animation as described above.

In some implementations, while the user continues to provide the touch input the slideshow presentation can be paused. Once the user ceases the touch input, the slideshow presentation can be resumed after showing the next or previous slide according to the user input. For example, the slideshow presentation can resume from the point in the slideshow where the initial touch input was received. For example, if a particular slide was displayed when the initial touch input was received, then the slideshow can resume automatic presentation of the slides in the slideshow from the particular slide. If the touch input was initiated while displaying a first slide and terminated halfway through a transition animation from the first slide to a second slide, then the computing device can present part of the transition animation for transitioning back to the first slide and resume automatic presentation of the slideshow presentation. Alternatively, the slideshow can resume from the point in the slideshow where the touch input was terminated. For example, if the touch input is terminated by the user halfway through a transition animation from a first slide to a second slide, then when the touch input is terminated the remaining portion of the transition animation can be presented until the second slide is displayed.

In some implementations, the transition animation control mechanisms described above can control slide or image animations. For example, each slide or image grouping can include animated images. An animated image can be a movie, an animated drawing, or some other type of animation, for example. When the user provides the touch and swipe inputs described above for performing a slide transition and/or controlling a slide transition animation while an image animation is being displayed, the image animation can be controlled using the touch input (e.g., single finger touch and swipe gesture). For example, if the animated image is a movie, if a single finger left swipe gesture is received while in the middle of playback of the movie, the movie can be fast forwarded to completion and the transition animation from the slide containing the movie to the next slide can be displayed. Similarly, if a right swipe gesture is received, the movie can be fast reversed and the transition animation to the previous slide can be displayed. Thus, the touch input and gesture can be used to control the playback of the animation and the transition animation between slides. In some implementations, when the single finger swipe gesture is received while an image animation is being presented, the image animation will simply stop and the transition animation for transitioning between slides can be presented and controlled, as described above.

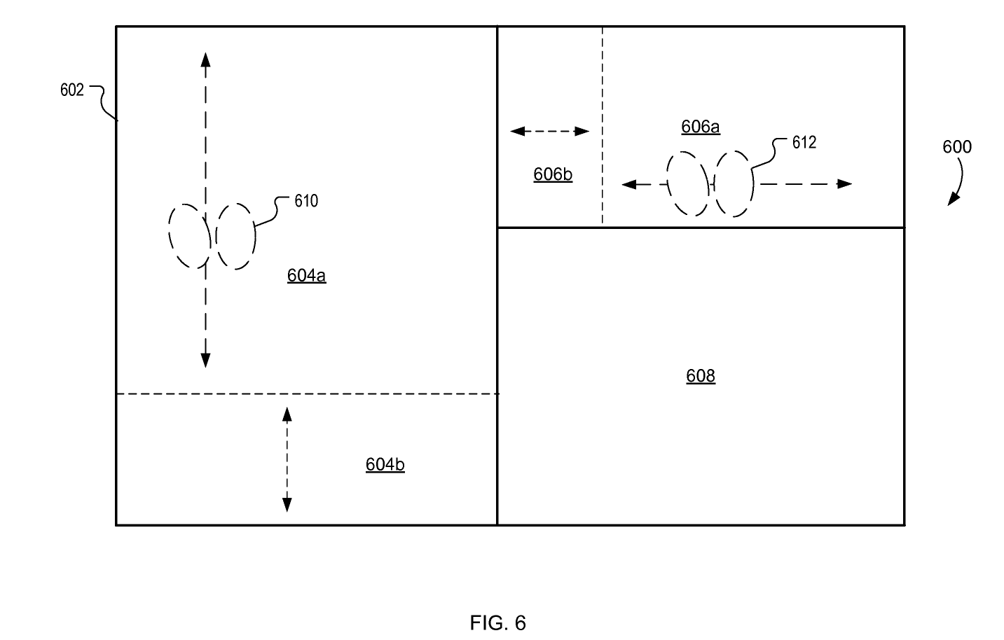

FIG. 6 illustrates a graphical user interface 600 for manipulating images displayed in slideshow presentation mode. For example, an image grouping (e.g., slide) 602 can be displayed that presents images 604 (a/b), 606 (a/b) and 608. Image 604 can include a displayed portion 604a and a hidden portion 604b. Likewise, image 606 can include a displayed portion 606a and a hidden portion 606b. Hidden portions 604b and 606b can be hidden if the image is too big (e.g., too long, too tall, etc.) to be fully displayed in image grouping 602. When image grouping 602 is initially displayed, images 604a, 606a and 608 can be displayed. If the user wishes to view the hidden portions of images 604b and 606b, the user can provide input with respect to the images to view the hidden portions. For example, the user can provide touch input 610 (e.g., two finger touch input) to image 604a and drag the touch input up (or down) to reveal hidden image portion 604b. Image 604 can be animated to slide upward (or downward) to reveal image portion 604b when the touch input is received and/or as long as the touch input continues, for example. When the touch input 610 is terminated, hidden image portion 604b can be hidden again and image 604a can be displayed. An animation can be displayed to show the hidden portion 604b retreating into the lower portion of the display while image portion 604b returns to its original position on the display.

Similarly, image 606a can be displayed when image grouping 602 is initially displayed. The user can provide touch input 612 to image 606a (e.g., two finger touch input) to image 606a and drag the touch input right (or left) to reveal hidden image portion 606b. Image 606 can be animated to slide right (or left) to reveal the hidden image portion 606b. Once the user terminates the touch input, image 606 can be animated to hide image portion 606b and return image portion 606a to its original position. Thus, the user can manipulate one image displayed on a slide without affecting other images displayed on the same slide.

### Example Processes

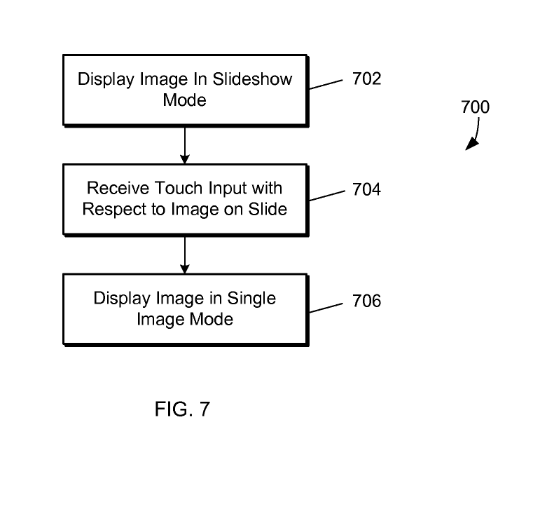

FIG. 7 is flow diagram of an example process 700 for navigating between slideshow presentation mode and single image presentation mode. An illustration and additional description of process 700 can be found in FIG. 3 and associated texts. For example, images (e.g., digital photographs, videos, graphics, etc.) stored on a computing device can be displayed in various presentations modes. At step 702, an image can be displayed in a slideshow presentation mode. For example, when in the slideshow presentation mode, the computing device can display a sequence of image groupings (e.g., slides) that include one or more images, as described above.

At step 704, the computing device can receive touch input from a user with respect to an image on a displayed slide. For example, the computing device can detect when the user touches a touch sensitive display (or other touch sensitive device). The computing device can analyze the touch input to determine the type of touch input received. For example, the computing device can detect one or more points of contact with the touch sensitive display. The computing device can detect movement of the points of contact to determine if a gesture input has been received. For example, the computing device can detect one finger swipe gestures, two finger swipe gestures, a pinch gesture, a de-pinch gesture or other gestures made while the user is touching the touch sensitive display. For example, if at step 704, the computing device detects user input in the form of a de-pinch gesture and with respect to an image displayed in the slideshow mode, then, at step 706, the computing device can change the image presentation mode from a slideshow mode to a single image mode. Thus, at step 706, the computing device can display the image associated with the touch input in single image mode.

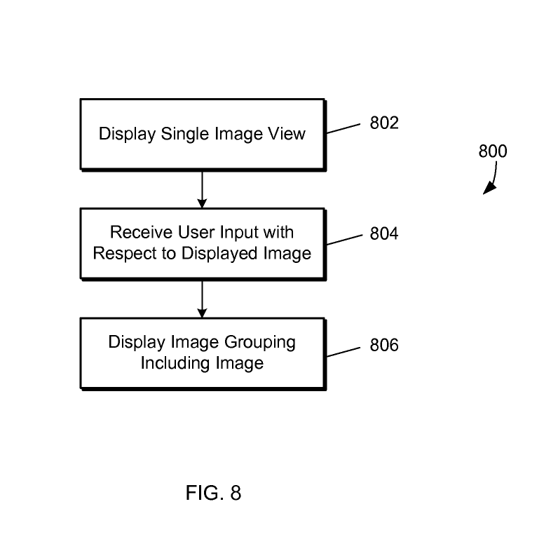

FIG. 8 is flow diagram of an example process 800 for navigating between single image presentation mode and slideshow presentation mode. An illustration and additional description of process 800 can be found in FIG. 3 and associated texts. At step 802, the computing device can display an image in single image presentation mode. At step 804, the computing device can receive user input with respect to the displayed image. For example, the computing device can detect touch input on an area of a touch sensitive display that is displaying the image. The touch input can be a pinch touch input gesture, for example. At step 806, the computing device can display an image grouping that includes the image displayed at step 802. For example, when the user input is received, the computing device can determine which “slide” in slideshow mode is configured to display the image presented in single image mode. The computing device can then display a slide or grouping of image that includes the image that was previously displayed in single image mode.

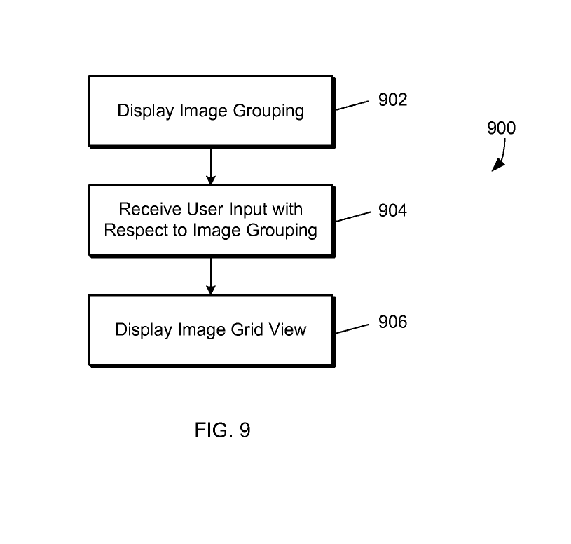

FIG. 9 is flow diagram of an example process 900 for navigating between slideshow presentation mode and grid view presentation mode. An illustration and additional description of process 900 can be found in FIG. 4 and associated texts. At step 902, an image grouping can be displayed. For example, a group of images (i.e., a slide) can be presented in slideshow mode on the display of a computing device. At step 904, the computing device can receive user input with respect to the displayed image grouping. For example, the user can input a pinch touch gesture to an area of a touch sensitive display that displays an image in the image grouping. At step 906, the computing device can display the images associated with the image library, album or collection associated with the slideshow in a grid view display. For example, the grid view display can be presented so that the image associated with the user input received in the slideshow mode is displayed and/or highlighted in the grid view display.

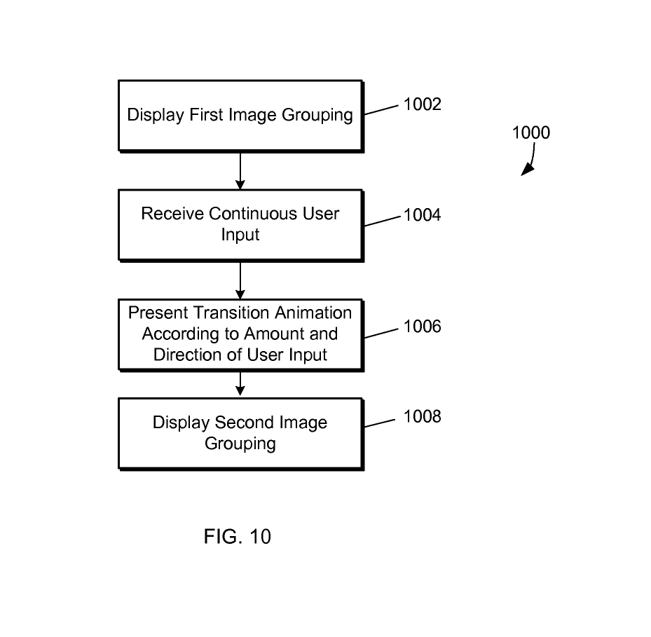

FIG. 10 is flow diagram of an example process 1000 for controlling transition animations. An illustration and additional description of process 1000 can be found in FIG. 5 and associated texts. For example, when in slideshow mode, the computing device can display a sequence of slides or image groupings that include images in an image library, album or collection stored on the computing device. The user can navigate through the sequence of slides manually by providing input to move from a currently displayed slide to the next or previous slide in the sequence. The computing device can be configured to automatically display the slides in the sequence of slides one after another. In some implementations, the transition from one slide to another slide can be animated. For example, the animation can include a fade in or out from one slide to another. The animation can include a slide or push animation that causes one slide to replace another slide using a horizontal or vertical sliding animation. The animation can include a flip animation that appears as if one slide is flipped over like a page or a card to reveal another slide. Other types of animations can be used to transition from one slide to another slide in the slideshow presentation mode.

At step 1002, the computing device can display a first image grouping or slide in a slideshow. At step 1004, the computing device can receive continuous user input for controlling the transition from one slide to another slide. For example, the user can provide continuous touch input to a touch sensitive display of the computing device. While continuing to receive the user's touch input, the computing device can pause the slideshow playback if the slideshow is configured to automatically display the sequence of slides in the slideshow. While continuing to receive the touch input, the computing device can determine the direction of the touch input. For example, the touch input can be a sliding or swipe touch input using a single finger. Based on the direction of the swipe touch input, the computing device can determine whether the previous or next slide in the slideshow should be displayed. For example, a leftward swipe input can cause the next slide to be displayed. A rightward swipe input can cause the previous slide to be displayed.

If the user continues to provide the touch input while inputting the swipe gesture, the user can control the transition animation. For example, if the computing device detects a leftward swipe input and determines that the user has not terminated the touch input, the computing device can display a portion of the transition animation associated with a transition from the current slide to the next slide. The portion of the transition animation displayed can correspond to the amount or distance covered by the leftward swipe touch input.

In some implementations, if the computing device detects that the user reverses the direction of the leftward swipe touch input without lifting the user's finger from the touch sensitive display, then the transition animation can be reversed or played backward on the display. For example, the user can control the amount and direction of the transition animation by providing continuous touch input to the touch sensitive display of the computing device. Thus, at step 1006, the computing device can present a transition animation from a first image grouping to a second image grouping according to the amount and direction of user input.

At step 1008, the computing device can display a second image grouping. For example, once the user terminates the touch input, the computing device can complete the transition animation and present the second image grouping. The second image grouping can be the same as the first image grouping, e.g., if the user provides the single finger swipe touch input and reverses direction back to the slide displayed when the touch input was initiated. The second image grouping can be a previous slide or the next slide in the sequence of slides. For example, the second image grouping can be the slide before the first slide or the slide after the first slide, depending on the direction of the swipe touch input.

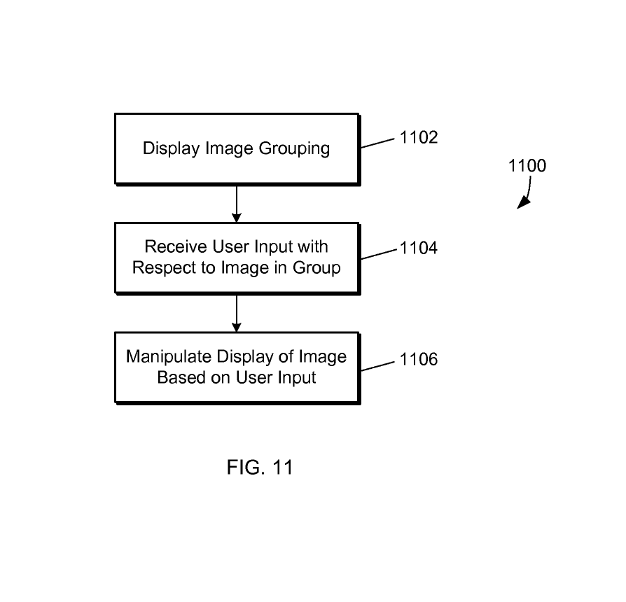

FIG. 11 is a flow diagram of an example process 1100 for manipulating an image displayed in an image grouping. An illustration and additional description of process 1100 can be found in FIG. 6 and associated texts. At step 1102, an image grouping or slide can be displayed on a display of a computing device. For example, an image grouping (i.e., a slide) in a slideshow presentation can include multiple images. An image displayed on a slide may be too big to be displayed within the space allocated to the image on the slide. Thus, portions of the image may be hidden so that the image can be displayed on the slide.

At step 1104, the computing device can receive user input with respect to an image displayed in the image grouping. For example, the user can provide touch input to a touch sensitive display of the computing device on an area of the display where the image is presented. The touch input can be, for example, a two finger touch input swipe gesture.

At step 1106, the computing device can manipulate the display of the image based on the user input. For example, in response to receiving the swipe gesture with respect to the image, the computing device can display the hidden portions of the image on the display.

In some implementations, the image displayed in an image grouping or slide can be a video image. The user can provide touch input to the portion of the touch sensitive display that is presenting the video image to manipulate (e.g., playback, fast forward, rewind, pause, etc.) the video displayed in the slide. The computing device can detect the touch input associated with the video image and perform the video manipulation indicated by the touch input.

### Example System Architecture

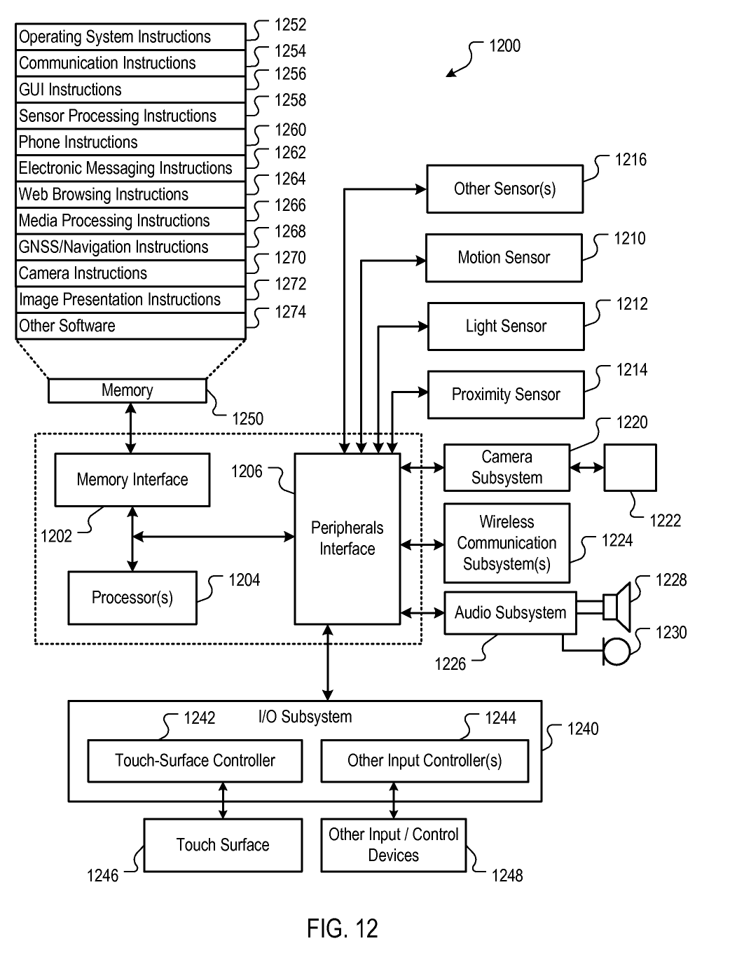

FIG. 12 is a block diagram of an example computing device 1200 that can implement the features and processes of FIGS. 1-11. The computing device 1200 can include a memory interface 1202, one or more data processors, image processors and/or central processing units 1204, and a peripherals interface 1206. The memory interface 1202, the one or more processors 1204 and/or the peripherals interface 1206 can be separate components or can be integrated in one or more integrated circuits. The various components in the computing device 1200 can be coupled by one or more communication buses or signal lines.

Sensors, devices, and subsystems can be coupled to the peripherals interface 1206 to facilitate multiple functionalities. For example, a motion sensor 1210, a light sensor 1212, and a proximity sensor 1214 can be coupled to the peripherals interface 1206 to facilitate orientation, lighting, and proximity functions. Other sensors 1216 can also be connected to the peripherals interface 1206, such as a global navigation satellite system (GNSS) (e.g., GPS receiver), a temperature sensor, a biometric sensor, magnetometer or other sensing device, to facilitate related functionalities.

A camera subsystem 1220 and an optical sensor 1222, e.g., a charged coupled device (CCD) or a complementary metal-oxide semiconductor (CMOS) optical sensor, can be utilized to facilitate camera functions, such as recording photographs and video clips. The camera subsystem 1220 and the optical sensor 1222 can be used to collect images of a user to be used during authentication of a user, e.g., by performing facial recognition analysis.

Communication functions can be facilitated through one or more wireless communication subsystems 1224, which can include radio frequency receivers and transmitters and/or optical (e.g., infrared) receivers and transmitters. The specific design and implementation of the communication subsystem 1224 can depend on the communication network(s) over which the computing device 1200 is intended to operate. For example, the computing device 1200 can include communication subsystems 1224 designed to operate over a GSM network, a GPRS network, an EDGE network, a Wi-Fi or WiMax network, and a Bluetooth™ network. In particular, the wireless communication subsystems 1224 can include hosting protocols such that the device 100 can be configured as a base station for other wireless devices.

An audio subsystem 1226 can be coupled to a speaker 1228 and a microphone 1230 to facilitate voice-enabled functions, such as speaker recognition, voice replication, digital recording, and telephony functions. The audio subsystem 1226 can be configured to facilitate processing voice commands, voiceprinting and voice authentication, for example.

The I/O subsystem 1240 can include a touch-surface controller 1242 and/or other input controller(s) 1244. The touch-surface controller 1242 can be coupled to a touch surface 1246. The touch surface 1246 and touch-surface controller 1242 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch surface 1246.

The other input controller(s) 1244 can be coupled to other input/control devices 1248, such as one or more buttons, rocker switches, thumb-wheel, infrared port, USB port, and/or a pointer device such as a stylus. The one or more buttons (not shown) can include an up/down button for volume control of the speaker 1228 and/or the microphone 1230.

In one implementation, a pressing of the button for a first duration can disengage a lock of the touch surface 1246; and a pressing of the button for a second duration that is longer than the first duration can turn power to the computing device 1200 on or off. Pressing the button for a third duration can activate a voice control, or voice command, module that enables the user to speak commands into the microphone 1230 to cause the device to execute the spoken command. The user can customize a functionality of one or more of the buttons. The touch surface 1246 can, for example, also be used to implement virtual or soft buttons and/or a keyboard.

In some implementations, the computing device 1200 can present recorded audio and/or video files, such as MP3, AAC, and MPEG files. In some implementations, the computing device 1200 can include the functionality of an MP3 player, such as an iPod™. The computing device 1200 can, therefore, include a 36-pin connector that is compatible with the iPod. Other input/output and control devices can also be used.

The memory interface 1202 can be coupled to memory 1250. The memory 1250 can include high-speed random access memory and/or non-volatile memory, such as one or more magnetic disk storage devices, one or more optical storage devices, and/or flash memory (e.g., NAND, NOR). The memory 1250 can store an operating system 1252, such as Darwin, RTXC, LINUX, UNIX, OS X, WINDOWS, or an embedded operating system such as VxWorks.

The operating system 1252 can include instructions for handling basic system services and for performing hardware dependent tasks. In some implementations, the operating system 1252 can be a kernel (e.g., UNIX kernel). In some implementations, the operating system 1252 can include instructions for performing voice authentication. For example, operating system 1252 can implement the image presentation and navigation features as described with reference to FIGS. 1-11.

The memory 1250 can also store communication instructions 1254 to facilitate communicating with one or more additional devices, one or more computers and/or one or more servers. The memory 1250 can include graphical user interface instructions 1256 to facilitate graphic user interface processing; sensor processing instructions 1258 to facilitate sensor-related processing and functions; phone instructions 1260 to facilitate phone-related processes and functions; electronic messaging instructions 1262 to facilitate electronic-messaging related processes and functions; web browsing instructions 1264 to facilitate web browsing-related processes and functions; media processing instructions 1266 to facilitate media processing-related processes and functions; GNSS/Navigation instructions 1268 to facilitate GNSS and navigation-related processes and instructions; and/or camera instructions 1270 to facilitate camera-related processes and functions.

The memory 1250 can store other software instructions 1272 to facilitate other processes and functions, such as the image presentation and navigation processes and functions as described with reference to FIGS. 1-11.

The memory 1250 can also store other software instructions 1274, such as web video instructions to facilitate web video-related processes and functions; and/or web shopping instructions to facilitate web shopping-related processes and functions. In some implementations, the media processing instructions 1266 are divided into audio processing instructions and video processing instructions to facilitate audio processing-related processes and functions and video processing-related processes and functions, respectively.

Each of the above identified instructions and applications can correspond to a set of instructions for performing one or more functions described above. These instructions need not be implemented as separate software programs, procedures, or modules. The memory 1250 can include additional instructions or fewer instructions. Furthermore, various functions of the computing device 1200 can be implemented in hardware and/or in software, including in one or more signal processing and/or application specific integrated circuits.

What is claimed is:

1. A method comprising:
initiating a slideshow presentation mode for displaying images associated with an image collection stored on a computing device;
displaying a first slide on a display of the computing device, the first slide including one or more images from the image collection;
receiving a de-pinch touch input gesture with respect to a particular image in the first slide;
switching from the slideshow presentation mode to a single image presentation mode, where the single image presentation mode presents only one image at a time;
presenting the particular image in the single image presentation mode.

2. The method of claim 1, further comprising:
presenting a first image in the single image presentation mode;
receiving a first pinch touch input gesture with respect to the first image;
switching from the single image presentation mode to the slideshow presentation mode;
presenting a second slide that includes at least the first image.

3. The method of claim 1, further comprising:
while in the single image presentation mode, determining that a period of time has elapsed since user input was received;
based on the determination, automatically switching back to slideshow presentation mode.

4. The method of claim 2, further comprising:
receiving a second pinch touch input gesture with respect to the second slide displayed in slideshow presentation mode;
switching from slideshow presentation mode to grid view presentation mode, where grid view presentation mode displays a grid of images associated with the image collection.

5. A method comprising:
initiating a slideshow presentation mode for displaying images associated with an image collection stored on a computing device;
displaying a first slide on a display of the computing device, the first slide including one or more images from the image collection;
receiving a one finger swipe touch input gesture;
while continuing to receive the touch input, manipulating a transition animation associated with transitioning from the first slide to a second slide.

6. The method of claim 5, wherein manipulating the transition animation comprises:
determining a direction of the one finger swipe touch input gesture;
determining a distance the touch input moves across the display of the computing device; and
manipulating the presentation of the transition animation according to the direction and the distance associated with the one finger swipe touch input gesture.

7. The method of claim 5, wherein manipulating the transition animation causes less than all of the transition animation to be presented.

8. The method of claim 5, wherein manipulating the transition animation causes the transition animation to be presented in reverse.

9. A method comprising:
initiating a slideshow presentation mode for displaying images associated with an image collection stored on a computing device;
displaying a first slide on a display of the computing device, the first slide including a plurality of images from the image collection, wherein a particular one of the images has a displayed portion and a hidden portion;
receiving a two finger swipe touch input gesture with respect to the particular image;
while continuing to receive the touch input, manipulating the display of the particular image so a that the hidden portion of the particular image is displayed.

10. The method of claim 9, further comprising:
detecting that the touch input gesture is no longer being received;
hiding the hidden portion of the image.

11. A system comprising:
one or more processors; and
a computer-readable medium including one or more sequences of instructions which, when executed by the one or more processors, causes:
initiating a slideshow presentation mode for displaying images associated with an image collection stored on a computing device;
displaying a first slide on a display of the computing device, the first slide including one or more images from the image collection;
receiving a de-pinch touch input gesture with respect to a particular image in the first slide;
switching from the slideshow presentation mode to a single image presentation mode, where the single image presentation mode presents only one image at a time;
presenting the particular image in the single image presentation mode.

12. The system of claim 11, wherein the instructions cause:
presenting a first image in the single image presentation mode;
receiving a first pinch touch input gesture with respect to the first image;
switching from the single image presentation mode to the slideshow presentation mode;
presenting a second slide that includes at least the first image.

13. The system of claim 11, wherein the instructions cause:
while in the single image presentation mode, determining that a period of time has elapsed since user input was received;
based on the determination, automatically switching back to slideshow presentation mode.

14. The system of claim 12, wherein the instructions cause:
receiving a second pinch touch input gesture with respect to the second slide displayed in slideshow presentation mode;
switching from slideshow presentation mode to grid view presentation mode, where grid view presentation mode displays a grid of images associated with the image collection.

15. A system comprising:
one or more processors; and
a computer-readable medium including one or more sequences of instructions which, when executed by the one or more processors, causes:
initiating a slideshow presentation mode for displaying images associated with an image collection stored on a computing device;
displaying a first slide on a display of the computing device, the first slide including one or more images from the image collection;
receiving a one finger swipe touch input gesture;
while continuing to receive the touch input, manipulating a transition animation associated with transitioning from the first slide to a second slide.

16. The system of claim 15, wherein the instructions that cause manipulating the transition animation include instructions that cause:
determining a direction of the one finger swipe touch input gesture;
determining a distance the touch input moves across the display of the computing device; and
manipulating the presentation of the transition animation according to the direction and the distance associated with the one finger swipe touch input gesture.

17. The system of claim 15, wherein manipulating the transition animation causes less than all of the transition animation to be presented.

18. The system of claim 15, wherein manipulating the transition animation causes the transition animation to be presented in reverse.

19. A system comprising:
one or more processors; and
a computer-readable medium including one or more sequences of instructions which, when executed by the one or more processors, causes:
initiating a slideshow presentation mode for displaying images associated with an image collection stored on a computing device;
displaying a first slide on a display of the computing device, the first slide including a plurality of images from the image collection, wherein a particular one of the images has a displayed portion and a hidden portion;
receiving a two finger swipe touch input gesture with respect to the particular image;
while continuing to receive the touch input, manipulating the display of the particular image so a that the hidden portion of the particular image is displayed.

20. The system of claim 19, wherein the instructions cause:
detecting that the touch input gesture is no longer being received;
hiding the hidden portion of the image.
